(19) United States
(12) Patent Application Publication
(10) Pub. No.: US 2025/0377974 A1
(43) Pub. Date: Dec. 11, 2025

(54) SECONDARY INTERFACE FOR A MEMORY SYSTEM

(71) Applicant: Micron Technology, Inc., Boise, ID (US)

(72) Inventors: Nicholas T. Heath, Pittsboro, NC (US); Gaurav Sinha, Unterschleißheim (DE)

(21) Appl. No.: 19/222,948

(22) Filed: May 29, 2025

Related U.S. Application Data
(60) Provisional application No. 63/658,789, filed on Jun. 11, 2024.

(51) Int. Cl. G06F 11/10; G06F 11/14; G06F 21/60

(52) U.S. Cl. CPC G06F 11/1048; G06F 11/1441; G06F 21/604

(57) ABSTRACT

Methods, systems, and devices for secondary interface for a memory system are described. A memory system may receive a command via a first interface that comprises a first set of one or more input/output (I/O) pins and that operates according to a first communication protocol comprising a first modulation scheme and a first data rate. The memory system may receive, via a second interface that comprises a second set of one or more I/O pins and that operates according to a second communication protocol comprising a second modulation scheme and a second data rate, a request for information from the memory system based on receiving the command. The memory system may transmit, via the second interface and in accordance with the second communication protocol, the information based on receiving the request.

### CROSS REFERENCE

The present application for patent claims priority to U.S. Patent Application No. 63/658,789 by Heath et al., entitled “SECONDARY INTERFACE FOR A MEMORY SYSTEM,” filed Jun. 11, 2024, which is assigned to the assignee hereof, and which is expressly incorporated by reference in its entirety herein.

### TECHNICAL FIELD

The following relates to one or more systems for memory, including a secondary interface for a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports a secondary interface for a memory system in accordance with examples as disclosed herein.

FIG. 2 shows an example of a system that supports a secondary interface for a memory system in accordance with examples as disclosed herein.

FIG. 3 shows an example of a process flow that supports a secondary interface for a memory system in accordance with examples as disclosed herein.

FIG. 4 shows a block diagram of a host system that supports a secondary interface for a memory system in accordance with examples as disclosed herein.

FIG. 5 shows a block diagram of a memory system that supports a secondary interface for a memory system in accordance with examples as disclosed herein.

FIGS. 6 and 7 show flowcharts illustrating a method or methods that support a secondary interface for a memory system in accordance with examples as disclosed herein.

### DETAILED DESCRIPTION

A system with multiple systems, such as a host system and a memory system, may include an interface that supports communication (e.g., via electronic signaling) between the multiple systems, such as the host system and the memory system. For example, the host system and the memory system may exchange information (e.g., commands, control information, data) via an interface that provides a communicative path between the host system and the memory system. The interface may include connections (e.g., input/output (I/O) pins, transmission lines) and interface logic (e.g., one or more transceiver, modulation circuitry, and encoding circuitry), among other things. In some cases, an issue at the memory system or with the interface may prevent communication via the interface. In such cases, the host system may be unable to trouble-shoot or remedy the issue due to an inability to communicate with the memory system via the interface.

According to the techniques and designs described herein, a system may include a secondary interface, in addition to the primary interface, that enables communication between the host system and the memory system. To reduce processing overhead and increase reliability, the secondary interface may use a communication protocol that is simpler and more robust than the primary interface. If the host system detects a condition indicative of an issue at the memory system or with the primary interface, the host system may take action, such as querying the memory system for information (e.g., diagnostic information) that allows the host system to determine the cause of the issue. The host system may then use the secondary interface to transmit commands to the memory system that resolve the issue. The host system may use the secondary interface, which may also be referred to as an out-of-band (OOB) interface, to receive status updates from the memory system, operating error information, protected information, or the like.

In addition to applicability in memory systems as described herein, techniques for a secondary interface for a memory system may be generally implemented to support increased connectivity of electronic systems. As the use of systems relying on interconnected electronic devices increases, the connectivity of these electronic devices becomes an increasingly relevant factor for the operations of the system. For example, delays associated with signals communicated between devices may become increasingly relevant as critical systems come to rely more on connectivity, as a system uses larger quantities of interconnected devices, or if the quantity and the complexity of signals communicated between devices increases. Implementing the techniques described herein may support techniques for increased connectivity in electronic systems by improving communication between devices, among other benefits.

In addition to applicability in memory systems as described herein, techniques for a secondary interface for a memory system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease processing or latency times, improve response times, or otherwise improve user experience, among other benefits.

In addition to applicability in memory systems as described herein, techniques for a secondary interface for a memory system may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by extending the life of electronic devices and thereby reducing electronic waste, among other benefits.

Features of the disclosure are illustrated and described in the context of systems, devices, and circuits. Features of the disclosure are further illustrated and described in the context of a process flow and flowcharts.

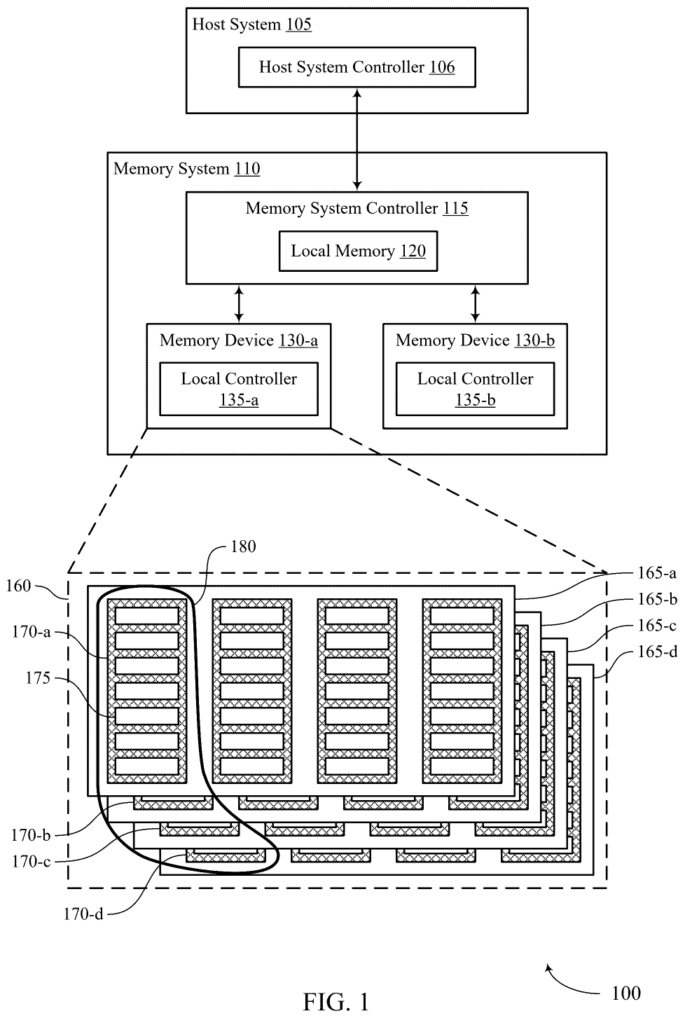

FIG. 1 shows an example of a system 100 that supports a secondary interface for a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include a primary interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via a primary interface. The host system 105 and the memory system 110 may, in some cases, be configured to communicate via a primary interface using an associated communication protocol (e.g., to exchange or otherwise communicate control, address, data, and other signals between the memory system 110 and the host system 105) that includes a modulation scheme, a data rate, and an error protection scheme. Examples of a physical host interface may include, but are not limited to, an mPHY interface, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the primary interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

As noted, the host system 105 and the memory system 110 may communicate (e.g., exchange electronic signaling) via a primary interface that uses a first communication protocol. For example, the host system 105 may send commands to the memory system 110 via the primary interface and may receive information from the memory system 110 via the primary interface, which may facilitate a high data rate. But if communication via the primary interface becomes unreliable, experiences high latency, or ceases altogether, the host system 105 may be unable to determine the underlying issue due to an inability to reliably and timely communicate with the memory system 110 via the primary interface. Accordingly, the host system 105 may take one or more drastic remedial measures (e.g., shutting down the system) in response to the primary interface failing, even if the underlying issue is resolvable.

According to the techniques and designs described herein, the system 100 may include a secondary interface that provides a second communication path (between the host system 105 and the memory system 110) that is separate from the communication path provided by the primary interface. The secondary interface may use a second communication protocol that is simpler and more robust than the primary interface. Based on detecting a trigger condition indicative of an issue at the memory system 110 or with the primary interface, the host system 105 may query the memory system 110, via the secondary interface, for information that allows the host system 105 to diagnose the underlying cause of the issue. If the underlying cause is resolvable, the host system 105 may communicate control information, via the secondary interface, to resolve the underlying cause, thus avoiding drastic remedial measures. If the underlying cause is not resolvable, the host system 105 may retrieve additional information, via the secondary interface, that is useful for debugging. Additionally, or alternatively, the host system 105 may use the secondary interface to retrieve other types of information, such as status information, operating error information, protected information, and the like.

The system 100 may include any quantity of non-transitory computer readable media that support secondary interface for a memory system. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

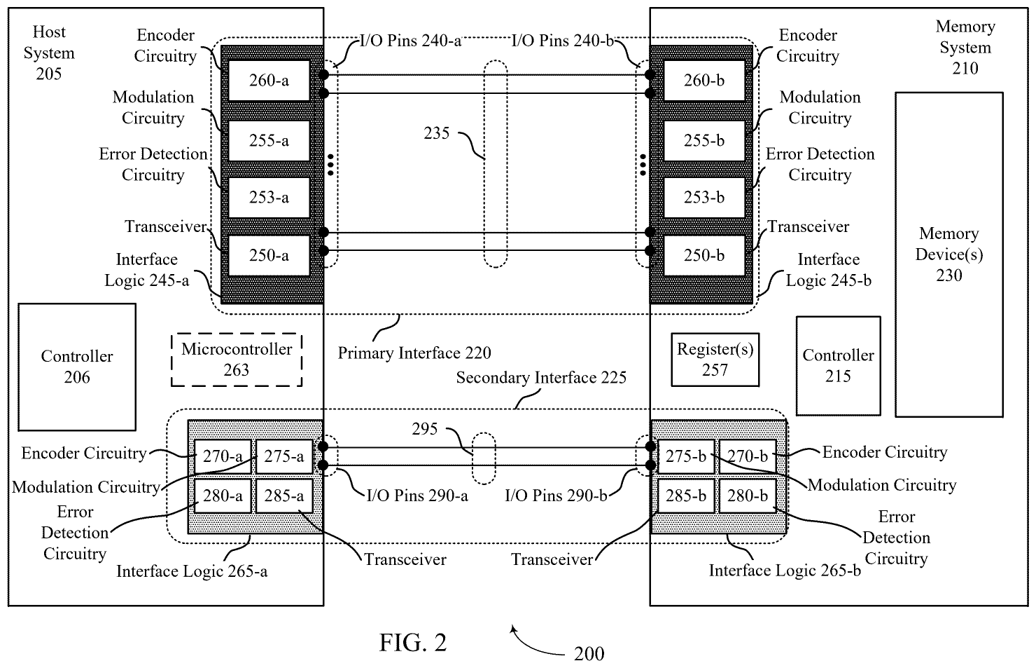

FIG. 2 shows an example of a system 200 that supports a secondary interface for a memory system in accordance with examples as disclosed herein. The system 200 may include a host system 205, which may be example of a host system 105 described with reference to FIG. 1. The system 200 may also include a memory system 210, which may be example of a memory system 115 described with reference to FIG. 1, and which may include one or more memory devices 230 configured to store information for the host system 205. The host system 205 may include a controller 206, which may be an example of a host system controller 106 as described with reference to FIG. 1. The memory system 210 may include a controller 215, which may be an example of a memory system controller 115 as described with reference to FIG. 1. The host system 205 and the memory system 210 may communicate via a primary interface 220 and a secondary interface 225, which may use different communication protocols. The respective components of the host system 205 and the respective components of the memory system 210 may be coupled in a manner that enables the operations described herein.

The primary interface 220 may be used to communicate signaling (e.g., commands, data), using a first communication protocol. The primary interface 220 may include one or more transmission lines 235 that terminate at respective I/O pins at the host system 205 (e.g., I/O pins 240-a) and the memory system 210 (e.g., I/O pins 240-b). The primary interface 220 may include interface logic 245-a that includes components that prepare outgoing signals for transmission from the host system 205 over the transmission lines 235 and that includes components that process incoming signals received at the host system 205 over the transmission lines 235. The primary interface 220 may also include interface logic 245-b that includes components that prepare outgoing signals for transmission from the memory system 210 over the transmission lines 235 and that includes components that process incoming signals received at the memory system 210 over the transmission lines 235.

In some cases, the host system 205 may be unable to communicate, at all or in a reliable and timely manner, over the primary interface 220 due to one or more issues at the memory system 210 or with the primary interface 220. In such cases, the host system 205 may detect a trigger condition for querying the memory system 210 via the secondary interface 225. For example, the host system 205 may determine that the response time of the memory system 210 to one or more commands exceeds a threshold latency. As another example, the host system 205 may determine that a response to a command has not been received from the memory system 210. As another example, the host system 205 may determine that a response (e.g., to a command) from the memory system 210 has a threshold quantity of errors, or that a threshold quantity of errors has been detected in responses received from the memory system 210 within a threshold duration of time.

In response to detecting the trigger condition, the host system 205 may transmit, via the secondary interface 225, a request for diagnostic information to the memory system 210, where diagnostic information refers to information that facilitates diagnosis of the underlying cause of the issue affecting communications via the primary interface 220. In response to the request, the memory system 210 may transmit, via the secondary interface 225, the diagnostic information. The host system 205 may determine one or more underlying causes of the trigger condition based on the diagnostic information and transmit, via the secondary interface 225, control information for resolving the cause(s) of the trigger condition.

In some examples, the control information may include an indication to reset the memory system 210. In some examples, the control information may include an indication to terminate one or more operations that are stalled (e.g., experiencing a threshold latency). For example, if attempts by the memory system 210 to execute an access command (e.g., a read command, a write command) are causing the memory system 210 to malfunction, have slow (e.g., high-latency) response times, or return data with high error-rates, the host system 205 may indicate that the memory system 210 is to discard the access command and terminate the associated operation. Additionally, or alternatively, the host system 205 may indicate a replacement access command (e.g., with a different memory address) that the memory system 210 is to execute instead of the discarded access command. In some examples (e.g., if the issue is address-specific), the host system 205 may instruct the memory system 210 to replace the address at issue with a backup address.

In some examples, the interface logic 245-a may include encoder circuitry 260-a (e.g., comprising an encoder circuit and a decoder circuit) that is configured to encode and decode signals (e.g., commands, control information) according to an encoding scheme (e.g., that maps commands to bit-strings) of the first communication protocol. The interface logic 245-a may also include error detection circuitry 253-a (e.g., comprising an encoder circuit and a decoder circuit) that is configured to encode and decode signals according to an error protection scheme (e.g., a first error protection scheme) of the first communication protocol. The interface logic 245-a may also include modulation circuitry 255-a (e.g., comprising an modulation circuit and a demodulation circuit) that is configured to modulate and demodulate signals according to a modulation scheme (e.g., a first modulation scheme) of the first communication protocol. The interface logic 245-a may also include one or more transceivers 250-a configured to transmit and receive signals (e.g., encoded and modulated signals) in accordance with the first communication protocol (e.g., according to the data rate, modulation scheme, and error protection scheme of the first communication protocol).

So, in the outgoing direction relative to the host system 205, a signal may be encoded by the encoder circuitry 260-a and the error detection circuitry 253-a, modulated by the modulation circuitry 255-a, and transmitted by the transceiver 250-a, potentially in that order. In the incoming direction relative to the host system 205, a signal may be received by the transceiver 250-a, demodulated by the modulation circuitry 255-a, and decoded by the error detection circuitry 253-a and the encoder circuitry 260-a, potentially in that order.

In some examples, the interface logic 245-b may include encoder circuitry 260-b (e.g., comprising an encoder circuit and a decoder circuit) that is configured to encode and decode signals (e.g., commands, control information) according to an encoding scheme of the first communication protocol. The interface logic 245-b may also include error detection circuitry 253-b (e.g., comprising an encoder circuit and a decoder circuit) that is configured to encode and decode signals according to an error protection scheme (e.g., the first error protection scheme) of the first communication protocol. The interface logic 245-b may also include modulation circuitry 255-b (e.g., comprising a modulation circuit and a demodulation circuit) that is configured to modulate and demodulate signals according to a modulation scheme (e.g., the first modulation scheme) of the first communication protocol. The interface logic 245-b may also include one or more transceivers 250-b configured to transmit and receive signals (e.g., encoded and modulated signals) in accordance with the first communication protocol (e.g., according to the data rate, modulation scheme, and error protection scheme of the first communication protocol).

So, in the outgoing direction relative to the memory system 210, a signal may be encoded by the encoder circuitry 260-b and the error detection circuitry 253-b, modulated by the modulation circuitry 255-b, and transmitted by the transceiver 250-b, potentially in that order. In the incoming direction relative to the memory system 210, a signal may be received by the transceiver 250-b, demodulated by the modulation circuitry 255-b, and decoded by the error detection circuitry 253-b and the encoder circuitry 260-b, potentially in that order.

The secondary interface 225 may be used to communicate signaling (e.g., commands, data), using a second communication protocol. The secondary interface 225 may include one or more transmission lines 295 that terminate at respective I/O pins at the host system 205 (e.g., I/O pins 290-a) and the memory system 210 (e.g., I/O pins 290-b). Although shown with two I/O pins 290 there may be any quantity of I/O pins 290, including one I/O pin 290. The I/O pins 290 may be configured to support serial or parallel communications in a unidirectional or bidirectional manner.

The secondary interface 225 may include interface logic 265-a that includes components that prepare outgoing signals for transmission from the host system 205 over the transmission line(s) 295 and that includes components that process incoming signals received at the host system 205 over the transmission line(s) 295. The secondary interface 225 may also include interface logic 265-b that includes components that prepare outgoing signals for transmission from the memory system 210 over the transmission line(s) 295 and that includes components that process incoming signals received at the memory system 210 over the transmission line(s) 295.

In some examples, the interface logic 265-a may include encoder circuitry 270-a (e.g., comprising an encoder circuit and a decoder circuit) that is configured to encode and decode signals (e.g., data, metadata, control information) according to an encoding scheme of the second communication protocol. The interface logic 265-a may also include error detection circuitry 280-a (e.g., comprising an encoder circuit and a decoder circuit) that is configured to encode and decode signals according to an error protection scheme (e.g., a second error protection scheme) of the second communication protocol. The interface logic 265-a may also include modulation circuitry 275-a (e.g., comprising a modulation circuit and a demodulation circuit) that is configured to modulate and demodulate signals according to a modulation scheme (e.g., a second modulation scheme) of the second communication protocol. The interface logic 265-a may also include one or more transceivers 285-a configured to transmit and receive signals (e.g., encoded and modulated signals) in accordance with the second communication protocol (e.g., according to the data rate, modulation scheme, and error protection scheme of the second communication protocol).

So, in the outgoing direction relative to the host system 205, a signal may be encoded by the encoder circuitry 270-a and the error detection circuitry 280-a, modulated by the modulation circuitry 275-a, and transmitted by the transceiver 285-a, potentially in that order. In the incoming direction relative to the host system 205, a signal may be received by the transceiver 285-a, demodulated by the modulation circuitry 275-a, and decoded by the error detection circuitry 280-a and the encoder circuitry 270-a, potentially in that order.

In some examples, the interface logic 265-b may include encoder circuitry 270-b (e.g., comprising an encoder circuit and a decoder circuit) that is configured to encode and decode signals (e.g., data, metadata, control information) according to the encoding scheme of the second communication protocol. The interface logic 265-b may also include error detection circuitry 280-b (e.g., comprising an encoder circuit and a decoder circuit) that is configured to encode and decode signals according to the error protection scheme (e.g., the second error protection scheme) of the second communication protocol. The interface logic 265-b may also include modulation circuitry 275-b (e.g., comprising a modulation circuit and a demodulation circuit) that is configured to modulate and demodulate signals according to the modulation scheme (e.g., the second modulation scheme) of the second communication protocol. The interface logic 265-b may also include one or more transceivers 285-b configured to transmit and receive signals (e.g., encoded and modulated signals) in accordance with the second communication protocol (e.g., according to the data rate, modulation scheme, and error protection scheme of the second communication protocol).

So, in the outgoing direction relative to the memory system 210, a signal may be encoded by the encoder circuitry 270-b and the error detection circuitry 280-b, modulated by the modulation circuitry 275-b, and transmitted by the transceiver 285-b, potentially in that order. In the incoming direction relative to the memory system 210, a signal may be received by the transceiver 285-b, demodulated by the modulation circuitry 275-b, and decoded by the error detection circuitry 280-b and the encoder circuitry 270-b, potentially in that order.

To support the use of different communication protocols, the primary interface 220 and the secondary interface 225 may have separate components that provide different functionality based on the different communication protocols. For example, the modulation circuitry 255 may be configured to modulate and demodulate signals according to the first modulation scheme whereas the modulation circuitry 275 may be configured to modulate and demodulate signals according to the second modulation scheme, which may be simpler (e.g., include fewer voltage levels) than the first modulation scheme. For instance, the first modulation scheme may be a pulse amplitude modulation (PAM) scheme that uses a higher quantity of levels than the second modulation scheme. Additionally, or alternatively, the difference between voltage levels may be larger in the second modulation scheme than in the first voltage scheme, which may increase reliability of the second modulation scheme at the expense of higher power consumption.

As another example, the error detection circuitry 253 may be configured to perform error detection and correction via encoding and decoding in accordance with the first error detection scheme (e.g., a first error correction code (ECC) scheme, a first cyclic redundancy check (CRC) scheme) whereas the error detection circuitry 280 may be configured to perform error detection and correction via encoding and decoding in accordance with the second error detection scheme (e.g., a second ECC scheme, a second CRC scheme). The first error detection scheme may be capable of detecting, and potentially correcting, a higher quantity of errors than the second error detection scheme, or vice versa.

As another example, the transceivers 250 may be configured to transmit signals in accordance with the first modulation scheme at the first data rate, whereas the transceivers 285 may be configured to transmit signals in accordance with the second modulation scheme at the second data rate. The second data rate may be slower than the first data rate to increase the reliability of communications via the secondary interface 225 relative to the communications via the primary interface 220.

In some examples, the host system 205 may use the secondary interface 225 to obtain register information from the memory system 210. For example, the host system 205 may request register information from one or more registers 257 of the memory system 210. The register information may comprise status information that indicates one or more statuses of the memory system 210. The host system 205 may obtain the status information while the primary interface 220 is operative or inoperative. In some examples, the host system 205 may use the secondary interface 225 to obtain operational error information from the memory system 210. For example, the host system 205 may request operational error information from the memory system 210, where operational error information may indicate one or more operating errors of the memory system 210. In some examples, the host system 205 may prompt the memory system 210 to use the secondary interface 225 to transmit information in real time (e.g., without additional prompting from the host system 205) as the memory system 210 operates.

In some examples, the host system 205 may use the secondary interface 225 to obtain protected information (e.g., vendor-specific information) from the memory system 210. The memory system 210 may store protected information that is accessible by authorized devices and that is inaccessible by unauthorized devices. To obtain access to the protected information, the host system 205 may transmit, via the secondary interface 225, authorization information (e.g., an authorized identifier) that indicates the host system 205 is authorized to access the protected information. In response to the authorization information, the memory system 210 may transmit the protected information via the secondary interface 225. Protected information may be any type of information, including diagnostic information, register information, and operational error information.

In some examples, the host system 205 may transmit the information received via the secondary interface 225 to device for debugging. To do so, the host system 205 may transmit the information via a third interface that is coupled with the host system 205 and the device for debugging. Thus, the secondary interface 225 may be used to obtain information for debugging that may otherwise be inaccessible (e.g., if the primary interface 220 is inoperative).

In some examples, the operations of the host system 205 described herein may be offloaded to a microcontroller 263 of the host system 205. The microcontroller 263 may be included in, or externally coupled with, the host system 205. The microcontroller 263 may communicate with the memory system 210 via the secondary interface 225 in response to prompts from the host system 205, autonomously (e.g., independent of prompts from the host system 205), or both. In some examples, one or more of the host-side components (e.g., the encoder circuitry 270-a, the error detection circuitry 280-a, the modulation circuitry 275-a, the transceiver 285-a) of the secondary interface 225 may be included in the microcontroller 263. So, in some examples, signals exchanged over the secondary interface 225 may be transmitted and received by the microcontroller 263.

Thus, the host system 205 and the memory system 210 may communicate via multiple interfaces that use different communication protocols.

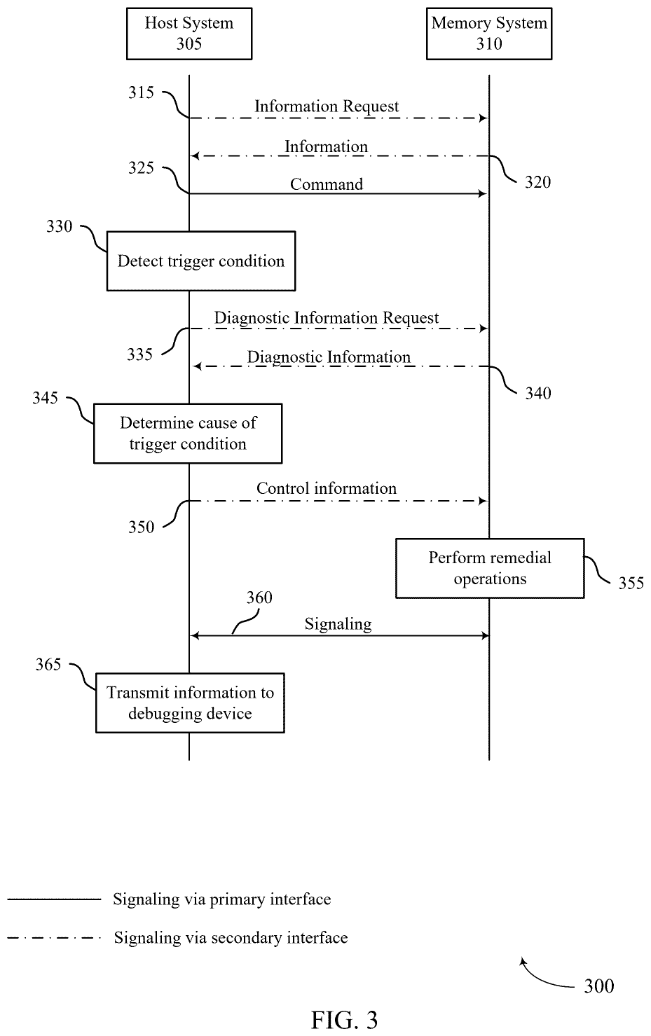

FIG. 3 shows an example of a process flow 300 that supports a secondary interface for a memory system in accordance with examples as disclosed herein. The process flow 300 may be implemented by a host system 305, which may be an example of a host system 105 or a host system 205, and a memory system 310, which may be an example of a memory system 110 or a memory system 210. The host system 305 and the memory system 310 may communicate via a primary interface and a secondary interface that use different communication protocols as described herein.

Aspects of the process flow 300 may be implemented by one or more controllers, among other components. Additionally, or alternatively, aspects of the process flow 300 may be implemented as instructions stored in one or more memories (e.g., firmware stored in one or more memories coupled with the host system 305, firmware stored in one or more memories coupled with the memory system 310). For example, the instructions, if executed by one or more controllers (e.g., the host system controller 106, the memory system controller 115, a local controller 135), may cause the one or more controllers (or a device or a system) to perform the operations of the process flow 300.

At 315, the host system 305 may transmit, via the secondary interface, a request for information (e.g., register information, operational error information, protected information). The request may be transmitted in accordance with the second communication protocol (e.g., the request may be transmitted using the second modulation scheme and the second data rate of the second communication protocol).

At 320, the memory system 310 may transmit, via the secondary interface and in accordance with the second communication protocol, the information requested by the host system 305. In some examples, transmission of the request at 315 and transmission of the information at 320 may be concurrent with (e.g., overlap at least partially in time with) communications transmitted between the two systems via the primary interface. At 325, the host system 305 may transmit, via the primary interface, a command to the memory system 310. The request may be transmitted in accordance with the first communication protocol (e.g., the request may be transmitted using the first modulation scheme and first data rate of the first communication protocol). The command may be transmitted in accordance with the first communication protocol (e.g., the command may be transmitted using the first modulation scheme and first data rate of the first communication protocol).

The command may be an access command (e.g., a read command, a write command) for the memory system 310 to access one or more memory devices or another type of command, such as a command to change operating modes. In some examples, the memory system 310 may attempt to transmit, via the primary interface, a response to the command. However, the response may not be received by the host system 305, or may be received with errors at the host system 305, due to an issue (e.g., a connection issue, an operating issue) with the primary interface. In other examples, the memory system 310 may transmit the response via the primary interface after a duration of time (e.g., relative to receipt of the command) that exceeds a threshold duration. That is, the memory system 310 may delayed in responding to the command due to one or more issues at the memory system 310.

At 330, the host system 305 may detect a trigger condition for querying the memory system 310 via the secondary interface. The trigger condition may be indicative of or associated with one or more issues at the memory system 310 or with the primary interface. For example, the host system 305 may detect the trigger condition if the host system 305 determines that a response to the command transmitted at 325 has not been received via the primary interface within the threshold duration of transmitting the command. As another example, the host system 305 may detect the trigger condition if the host system 305 determines that a response to the command transmitted at 325 includes a threshold quantity of errors. In some examples, the trigger condition may be the memory system 310 transmitting an indication that there is an issue with the primary interface. The memory system 310 may transmit such an indication if the memory system 310 determines that one or more commands received by the memory system 310 include(s) a threshold quantity of errors.

At 335, the host system 305 may, based on (e.g., in response to) detecting the trigger condition, transmit to the memory system 310 a request for information (e.g., diagnostic information) via the secondary interface. The request may be transmitted in accordance with the second communication protocol (e.g., the request may be transmitted using the second modulation scheme and the second data rate of the second communication protocol).

At 340, the memory system 310 may transmit the diagnostic information via the secondary interface and in accordance with the second communication protocol. The memory system 310 may transmit the diagnostic information based on (e.g., in response to) the request received at 335. At 345, the host system 305 may determine, based on the diagnostic information, one or more causes of the issue(s) associated with the trigger condition.

At 350, the host system 305 may transmit, via the secondary interface and in accordance with the second communication protocol, control information for resolving the issue(s) and/or trigger condition. At 355, the memory system 310 may perform, based on the control information, one or more remedial operations for resolving the issue(s) and/or trigger condition. In some examples, the remedial operations may restore operability of the primary interface. In some examples, the control information may be a command for the memory system 310 to perform a reset operation and the memory system 310 may, at 355, perform the reset operation based on receiving the command. In some examples, the control information may be a command for the memory system 310 to terminate one or more operations and the memory system 310 may, at 355, terminate the one or more operations based on receiving the command.

At 360, the host system 305 and the memory system 310 may exchange signaling via the primary interface based at least in part on the memory system 310 performing the one or more remedial operations. In some examples, the signaling at 360 may occur based on the host system 305 determining that the operability of the primary interface has been restored. At 365, the host system 305 may transmit, via a third interface, information to a device for debugging. The information may include the diagnostic information received at 340, register information, operational error information, protected information, or other types of information.

Thus, the host system 305 and the memory system 310 may communicate via a primary interface and a secondary interface that use different communication protocols as described herein. Alternative examples of the foregoing may be implemented, where some operations are performed in a different order than described, are performed in parallel, or are not performed at all. In some cases, operations may include additional features not mentioned herein, or further operations may be added. Additionally, certain operations may be performed multiple times or certain combinations of operations may repeat or cycle.

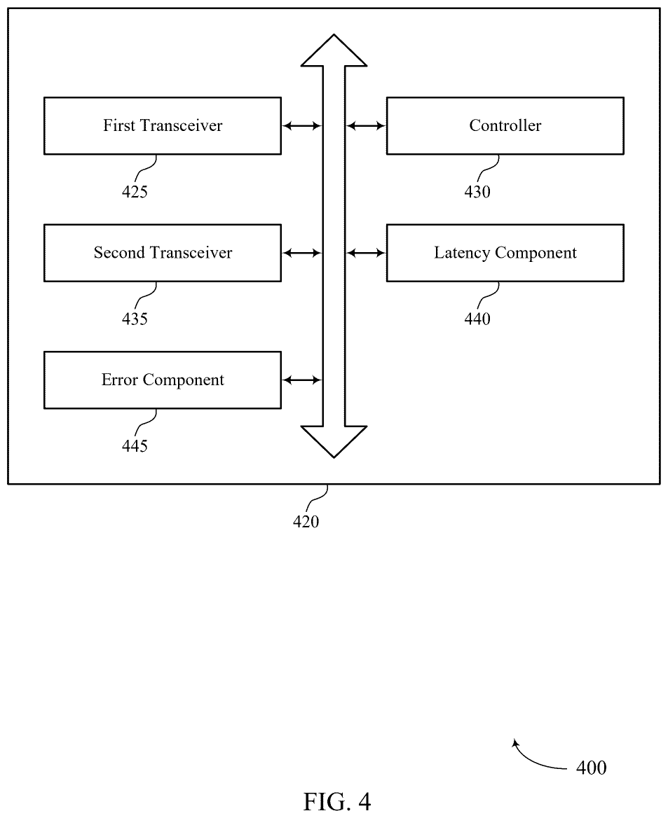

FIG. 4 shows a block diagram 400 of a host system 420 that supports a secondary interface for a memory system in accordance with examples as disclosed herein. The host system 420 may be an example of aspects of a host system as described with reference to FIGS. 1 through 3. The host system 420, or various components thereof, may be an example of means for performing various aspects of secondary interface for a memory system as described herein. For example, the host system 420 may include a first transceiver 425, a controller 430, a second transceiver 435, a latency component 440, an error component 445, or any combination thereof. Each of these components, or components of subcomponents thereof (e.g., one or more processors, one or more memories), may communicate, directly or indirectly, with one another (e.g., via one or more buses).

The first transceiver 425 may be configured as or otherwise support a means for transmitting, by a host system, a command to a memory system via a first interface that includes a first set of one or more I/O pins and that operates according to a first communication protocol including a first modulation scheme and a first data rate. The controller 430 may be configured as or otherwise support a means for detecting, based on transmitting the command via the first interface, a trigger condition to query the memory system via a second interface that includes a second set of one or more I/O pins and that operates according to a second communication protocol including a second modulation scheme and a second data rate. The second transceiver 435 may be configured as or otherwise support a means for transmitting, by the host system via the second interface and in accordance with the second communication protocol, a request for information from the memory system based on detecting the trigger condition to query the memory system. In some examples, the second transceiver 435 may be configured as or otherwise support a means for receiving, by the host system via the second interface and in accordance with the second communication protocol, the information from the memory system based on transmitting the request.

In some examples, the second transceiver 435 may be configured as or otherwise support a means for transmitting, via the second interface, authorization information that indicates the host system is authorized to access the information, where the information is received based on transmitting the authorization information.

In some examples, the first communication protocol includes a first error protection scheme and the second communication protocol includes a second error protection scheme.

In some examples, to support detecting the trigger condition, the latency component 440 may be configured as or otherwise support a means for determining that a response to the command has not been received via the first interface within a threshold duration of transmitting the command.

In some examples, to support detecting the trigger condition, the error component 445 may be configured as or otherwise support a means for determining that a response to the command received via the first interface includes an error.

In some examples, the second transceiver 435 may be configured as or otherwise support a means for transmitting, via the second interface, an indication to reset the memory system based on the information.

In some examples, the information includes diagnostic information, and the controller 430 may be configured as or otherwise support a means for determining a cause of the trigger condition based on the diagnostic information. In some examples, the information includes diagnostic information, and the second transceiver 435 may be configured as or otherwise support a means for transmitting, via the second interface, control information for resolving the cause of the trigger condition.

In some examples, the second transceiver 435 may be configured as or otherwise support a means for transmitting, via the second interface, a request for register information that indicates one or more statuses of the memory system. In some examples, the second transceiver 435 may be configured as or otherwise support a means for receiving, over the second interface, the register information based on transmitting the request for register information.

In some examples, the second transceiver 435 may be configured as or otherwise support a means for transmitting, via the second interface, a request for operational error information that indicates one or more operating errors of the memory system. In some examples, the second transceiver 435 may be configured as or otherwise support a means for receiving, via the second interface, the operational error information based on transmitting the request for operational error information.

In some examples, the first interface may include a first transceiver (e.g., transceiver 250-a) at the host system, a first modulation circuit (e.g., in modulation circuitry 255-a) at the host system, and a first encoder circuit (e.g., in encoder circuitry 260-a or in error detection circuitry 253-a) at the host system; and the second interface may include a second transceiver (e.g., transceiver 285-a) at the host system, a second modulation circuit (e.g., in modulation circuitry 275-a) at the host system, and a second encoder circuit (e.g., in encoder circuitry 270-a or in error detection circuitry 280-a) at the host system.

In some examples, the first interface may include a first demodulation circuit (e.g., in modulation circuitry 255-a) at the host system and a first decoder circuit (e.g., in encoder circuitry 260-a or in error detection circuitry 253-a) at the host system; and the second interface may include a second demodulation circuit (e.g., in modulation circuitry 275-a) at the host system and a second decoder circuit (in encoder circuitry 270-a or in error detection circuitry 280-a) at the host system. In some examples, the request for information is transmitted by a microcontroller of the host system.

In some examples, the described functionality of the host system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 420, or various components thereof, may be implemented at least in part by instructions (e.g., stored in memory, non-transitory computer-readable medium) executable by at least one processor.

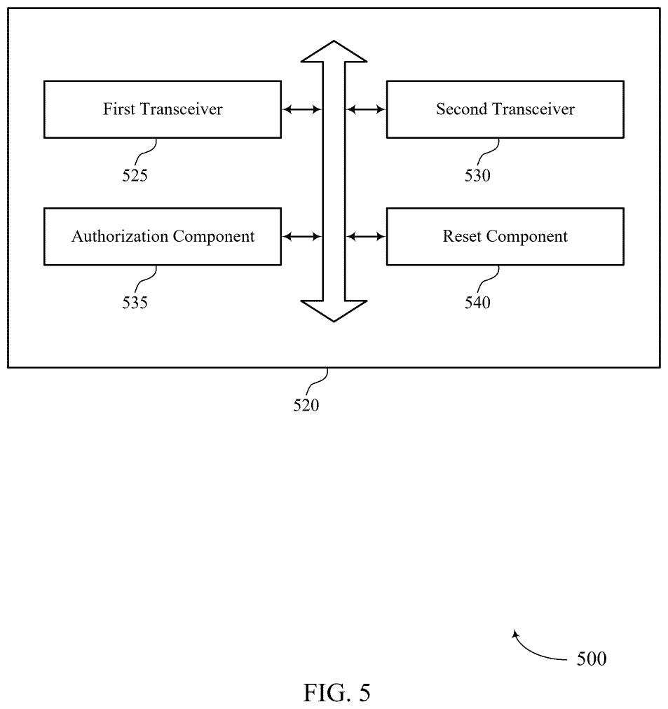

FIG. 5 shows a block diagram 500 of a memory system 520 that supports a secondary interface for a memory system in accordance with examples as disclosed herein. The memory system 520 may be an example of aspects of a memory system as described with reference to FIGS. 1 through 3. The memory system 520, or various components thereof, may be an example of means for performing various aspects of secondary interface for a memory system as described herein. For example, the memory system 520 may include a first transceiver 525, a second transceiver 530, an authorization component 535, a reset component 540, or any combination thereof. Each of these components, or components of subcomponents thereof (e.g., one or more processors, one or more memories), may communicate, directly or indirectly, with one another (e.g., via one or more buses).

The first transceiver 525 may be configured as or otherwise support a means for receiving, by a memory system, a command via a first interface that includes a first set of one or more I/O pins and that operates according to a first communication protocol including a first modulation scheme and a first data rate. The second transceiver 530 may be configured as or otherwise support a means for receiving, by the memory system via a second interface that includes a second set of one or more I/O pins and that operates according to a second communication protocol including a second modulation scheme and a second data rate, a request for information from the memory system based on receiving the command. In some examples, the second transceiver 530 may be configured as or otherwise support a means for transmitting, by the memory system via the second interface and in accordance with the second communication protocol, the information based on receiving the request.

In some examples, the authorization component 535 may be configured as or otherwise support a means for receiving, via the second interface, authorization information that indicates a host system is authorized to access the information, where the information is transmitted based on receiving the authorization information.

In some examples, the first communication protocol includes a first error protection scheme and the second communication protocol includes a second error protection scheme.

In some examples, the first transceiver 525 may be configured as or otherwise support a means for transmitting, via the first interface, a response to the command based on receiving the command, where the request is received based on transmitting the response.

In some examples, the reset component 540 may be configured as or otherwise support a means for receiving, via the second interface, an indication to reset the memory system based on the information. In some examples, the reset component 540 may be configured as or otherwise support a means for performing a reset operation to reset the memory system based on receiving the indication.

In some examples, the second transceiver 530 may be configured as or otherwise support a means for receiving, via the second interface, a request for register information that indicates one or more statuses of the memory system. In some examples, the second transceiver 530 may be configured as or otherwise support a means for transmitting, via the second interface, the register information based on receiving the request for the register information.

In some examples, the second transceiver 530 may be configured as or otherwise support a means for receiving, via the second interface, a request for operational error information that indicates one or more operating errors of the memory system. In some examples, the second transceiver 530 may be configured as or otherwise support a means for receiving, over the second interface, the operational error information based on transmitting the request for the operational error information.

In some examples, the first interface may include a first transceiver (e.g., transceiver 250-b) at the memory system, a first modulation circuit (e.g., in modulation circuitry 255-b) at the memory system, and a first encoder circuit (e.g., in encoder circuitry 260-b or in error detection circuitry 253-b) at the memory system; and the second interface may include a second transceiver (e.g., transceiver 285-b) at the memory system, a second modulation circuit (e.g., in modulation circuitry 275-b) at the memory system, and a second encoder circuit (e.g., in encoder circuitry 270-b or in error detection circuitry 280-b) at the memory system.

In some examples, the first interface may include a first demodulation circuit (e.g. in modulation circuitry 255-b) at the memory system and a first decoder circuit (e.g., in encoder circuitry 260-b or in error detection circuitry 253-b) at the memory system; and the second interface may include a second demodulation circuit (e.g., in modulation circuitry 275-b) at the memory system and a second decoder circuit (e.g., in encoder circuitry 270-b or in error detection circuitry 280-b) at the memory system.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by at least one processor.

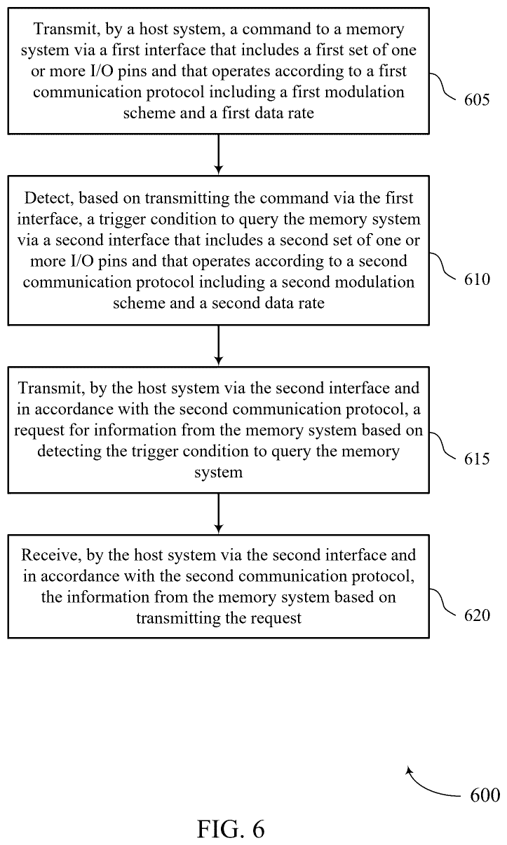

FIG. 6 shows a flowchart illustrating a method 600 that supports a secondary interface for a memory system in accordance with examples as disclosed herein. The operations of method 600 may be implemented by a host system or its components as described herein. For example, the operations of method 600 may be performed by a host system as described with reference to FIGS. 1 through 4. In some examples, a host system may execute a set of instructions to control the functional elements of the device to perform the described functions. Additionally, or alternatively, the host system may perform aspects of the described functions using special-purpose hardware.

At 605, the method may include transmitting, by a host system, a command to a memory system via a first interface that includes a first set of one or more I/O pins and that operates according to a first communication protocol including a first modulation scheme and a first data rate. In some examples, aspects of the operations of 605 may be performed by a first transceiver 425 as described with reference to FIG. 4.

At 610, the method may include detecting, based on transmitting the command via the first interface, a trigger condition to query the memory system via a second interface that includes a second set of one or more I/O pins and that operates according to a second communication protocol including a second modulation scheme and a second data rate. In some examples, aspects of the operations of 610 may be performed by a controller 430 as described with reference to FIG. 4.

At 615, the method may include transmitting, by the host system via the second interface and in accordance with the second communication protocol, a request for information from the memory system based on detecting the trigger condition to query the memory system. In some examples, aspects of the operations of 615 may be performed by a second transceiver 435 as described with reference to FIG. 4.

At 620, the method may include receiving, by the host system via the second interface and in accordance with the second communication protocol, the information from the memory system based on transmitting the request. In some examples, aspects of the operations of 620 may be performed by a second transceiver 435 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for transmitting, by a host system, a command to a memory system via a first interface that includes a first set of one or more I/O pins and that operates according to a first communication protocol including a first modulation scheme and a first data rate; detecting, based on transmitting the command via the first interface, a trigger condition to query the memory system via a second interface that includes a second set of one or more I/O pins and that operates according to a second communication protocol including a second modulation scheme and a second data rate; transmitting, by the host system via the second interface and in accordance with the second communication protocol, a request for information from the memory system based on detecting the trigger condition to query the memory system; and receiving, by the host system via the second interface and in accordance with the second communication protocol, the information from the memory system based on transmitting the request.

Aspect 2: The method, apparatus, or non-transitory computer-readable medium of aspect 1, further including operations, features, circuitry, logic, means, or instructions, or any combination thereof for transmitting, via the second interface, authorization information that indicates the host system is authorized to access the information, where the information is received based on transmitting the authorization information.

Aspect 3: The method, apparatus, or non-transitory computer-readable medium of any of aspects 1 through 2, where the first communication protocol includes a first error protection scheme and the second communication protocol includes a second error protection scheme.

Aspect 4: The method, apparatus, or non-transitory computer-readable medium of any of aspects 1 through 3, where detecting the trigger condition includes operations, features, circuitry, logic, means, or instructions, or any combination thereof for determining that a response to the command has not been received via the first interface within a threshold duration of transmitting the command.

Aspect 5: The method, apparatus, or non-transitory computer-readable medium of any of aspects 1 through 4, where detecting the trigger condition includes operations, features, circuitry, logic, means, or instructions, or any combination thereof for determining that a response to the command received via the first interface includes an error.

Aspect 6: The method, apparatus, or non-transitory computer-readable medium of any of aspects 1 through 5, further including operations, features, circuitry, logic, means, or instructions, or any combination thereof for transmitting, via the second interface, an indication to reset the memory system based on the information.

Aspect 7: The method, apparatus, or non-transitory computer-readable medium of any of aspects 1 through 6, where the information includes diagnostic information and the method, apparatuses, and non-transitory computer-readable medium further includes operations, features, circuitry, logic, means, or instructions, or any combination thereof for determining a cause of the trigger condition based on the diagnostic information and transmitting, via the second interface, control information for resolving the cause of the trigger condition.

Aspect 8: The method, apparatus, or non-transitory computer-readable medium of any of aspects 1 through 7, further including operations, features, circuitry, logic, means, or instructions, or any combination thereof for transmitting, via the second interface, a request for register information that indicates one or more statuses of the memory system and receiving, over the second interface, the register information based on transmitting the request for register information.

Aspect 9: The method, apparatus, or non-transitory computer-readable medium of any of aspects 1 through 8, further including operations, features, circuitry, logic, means, or instructions, or any combination thereof for transmitting, via the second interface, a request for operational error information that indicates one or more operating errors of the memory system and receiving, via the second interface, the operational error information based on transmitting the request for operational error information.

Aspect 10: The method, apparatus, or non-transitory computer-readable medium of any of aspects 1 through 9, where the first interface includes operations, features, circuitry, logic, means, or instructions, or any combination thereof for a first transceiver at the host system, a first modulation circuit at the host system, and a first encoder circuit at the host system; and where the second interface includes: a second transceiver at the host system, a second modulation circuit at the host system, and a second encoder circuit at the host system.

Aspect 11: The method, apparatus, or non-transitory computer-readable medium of aspect 10, where the first interface includes operations, features, circuitry, logic, means, or instructions, or any combination thereof for a first demodulation circuit at the host system and a first decoder circuit at the host system; and where the second interface includes: a second demodulation circuit at the host system and a second decoder circuit at the host system.

Aspect 12: The method, apparatus, or non-transitory computer-readable medium of any of aspects 1 through 11, where the request for information is transmitted by a microcontroller of the host system.

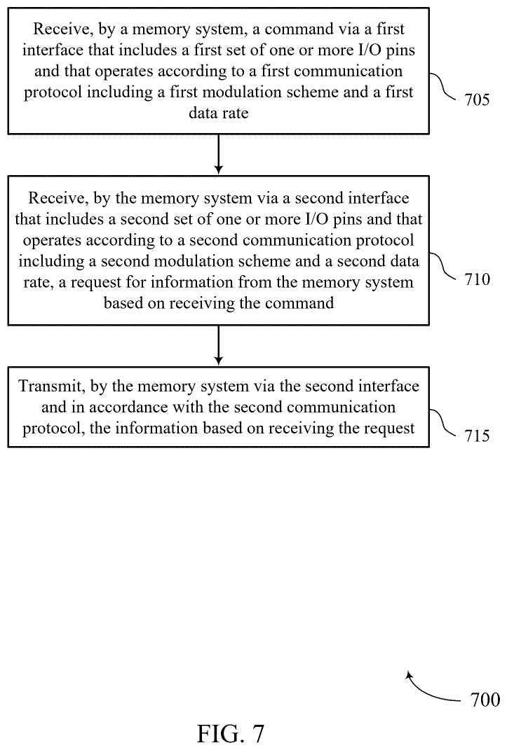

FIG. 7 shows a flowchart illustrating a method 700 that supports a secondary interface for a memory system in accordance with examples as disclosed herein. The operations of method 700 may be implemented by a memory system or its components as described herein. For example, the operations of method 700 may be performed by a memory system as described with reference to FIGS. 1 through 3 and 5. In some examples, a memory system may execute a set of instructions to control the functional elements of the device to perform the described functions. Additionally, or alternatively, the memory system may perform aspects of the described functions using special-purpose hardware.

At 705, the method may include receiving, by a memory system, a command via a first interface that includes a first set of one or more I/O pins and that operates according to a first communication protocol including a first modulation scheme and a first data rate. In some examples, aspects of the operations of 705 may be performed by a first transceiver 525 as described with reference to FIG. 5.

At 710, the method may include receiving, by the memory system via a second interface that includes a second set of one or more I/O pins and that operates according to a second communication protocol including a second modulation scheme and a second data rate, a request for information from the memory system based on receiving the command. In some examples, aspects of the operations of 710 may be performed by a second transceiver 530 as described with reference to FIG. 5.

At 715, the method may include transmitting, by the memory system via the second interface and in accordance with the second communication protocol, the information based on receiving the request. In some examples, aspects of the operations of 715 may be performed by a second transceiver 530 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 13: A method, apparatus, or non-transitory computer-readable medium including operations, features, circuitry, logic, means, or instructions, or any combination thereof for receiving, by a memory system, a command via a first interface that includes a first set of one or more I/O pins and that operates according to a first communication protocol including a first modulation scheme and a first data rate; receiving, by the memory system via a second interface that includes a second set of one or more I/O pins and that operates according to a second communication protocol including a second modulation scheme and a second data rate, a request for information from the memory system based on receiving the command; and transmitting, by the memory system via the second interface and in accordance with the second communication protocol, the information based on receiving the request.

Aspect 14: The method, apparatus, or non-transitory computer-readable medium of aspect 13, further including operations, features, circuitry, logic, means, or instructions, or any combination thereof for receiving, via the second interface, authorization information that indicates a host system is authorized to access the information, where the information is transmitted based on receiving the authorization information.

Aspect 15: The method, apparatus, or non-transitory computer-readable medium of any of aspects 13 through 14, where the first communication protocol includes a first error protection scheme and the second communication protocol includes a second error protection scheme.

Aspect 16: The method, apparatus, or non-transitory computer-readable medium of any of aspects 13 through 15, further including operations, features, circuitry, logic, means, or instructions, or any combination thereof for transmitting, via the first interface, a response to the command based on receiving the command, where the request is received based on transmitting the response.

Aspect 17: The method, apparatus, or non-transitory computer-readable medium of any of aspects 13 through 16, further including operations, features, circuitry, logic, means, or instructions, or any combination thereof for receiving, via the second interface, an indication to reset the memory system based on the information and performing a reset operation to reset the memory system based on receiving the indication.

Aspect 18: The method, apparatus, or non-transitory computer-readable medium of any of aspects 13 through 17, further including operations, features, circuitry, logic, means, or instructions, or any combination thereof for receiving, via the second interface, a request for register information that indicates one or more statuses of the memory system and transmitting, via the second interface, the register information based on receiving the request for the register information.

Aspect 19: The method, apparatus, or non-transitory computer-readable medium of any of aspects 13 through 18, further including operations, features, circuitry, logic, means, or instructions, or any combination thereof for receiving, via the second interface, a request for operational error information that indicates one or more operating errors of the memory system and receiving, over the second interface, the operational error information based on transmitting the request for the operational error information.

Aspect 20: The method, apparatus, or non-transitory computer-readable medium of any of aspects 13 through 19, where the first interface includes operations, features, circuitry, logic, means, or instructions, or any combination thereof for a first transceiver at the memory system, a first modulation circuit at the memory system, and a first encoder circuit at the memory system; and where the second interface includes: a second transceiver at the memory system, a second modulation circuit at the memory system, and a second encoder circuit at the memory system.

Aspect 21: The method, apparatus, or non-transitory computer-readable medium of aspect 20, where the first interface includes operations, features, circuitry, logic, means, or instructions, or any combination thereof for a first demodulation circuit at the memory system and a first decoder circuit at the memory system; and where the second interface includes: a second demodulation circuit at the memory system and a second decoder circuit at the memory system.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
receiving, by a memory system, a command via a first interface that comprises a first set of one or more input/output (I/O) pins and that operates according to a first communication protocol comprising a first modulation scheme and a first data rate;
receiving, by the memory system via a second interface that comprises a second set of one or more I/O pins and that operates according to a second communication protocol comprising a second modulation scheme and a second data rate, a request for information from the memory system based on receiving the command; and
transmitting, by the memory system via the second interface and in accordance with the second communication protocol, the information based on receiving the request.

2. The method of claim 1, further comprising:
receiving, via the second interface, authorization information that indicates a host system is authorized to access the information, wherein the information is transmitted based on receiving the authorization information.

3. The method of claim 1, wherein the first communication protocol comprises a first error protection scheme and the second communication protocol comprises a second error protection scheme.

4. The method of claim 1, further comprising:
transmitting, via the first interface, a response to the command based on receiving the command, wherein the request is received based on transmitting the response.

5. The method of claim 1, further comprising:
receiving, via the second interface, an indication to reset the memory system based on the information; and
performing a reset operation to reset the memory system based on receiving the indication.

6. The method of claim 1, further comprising:
receiving, via the second interface, a request for register information that indicates one or more statuses of the memory system; and
transmitting, via the second interface, the register information based on receiving the request for the register information.

7. The method of claim 1, further comprising:
receiving, via the second interface, a request for operational error information that indicates one or more operating errors of the memory system; and
receiving, over the second interface, the operational error information based on transmitting the request for the operational error information.

8. The method of claim 1, wherein the first interface comprises:
a first transceiver at the memory system, a first modulation circuit at the memory system, and a first encoder circuit at the memory system; and wherein the second interface comprises: a second transceiver at the memory system, a second modulation circuit at the memory system, and a second encoder circuit at the memory system; and
a first demodulation circuit at the memory system and a first decoder circuit at the memory system; and wherein the second interface comprises: a second demodulation circuit at the memory system and a second decoder circuit at the memory system.

9. A method, comprising:
transmitting, by a host system, a command to a memory system via a first interface that comprises a first set of one or more input/output (I/O) pins and that operates according to a first communication protocol comprising a first modulation scheme and a first data rate;
detecting, based on transmitting the command via the first interface, a trigger condition to query the memory system via a second interface that comprises a second set of one or more I/O pins and that operates according to a second communication protocol comprising a second modulation scheme and a second data rate;
transmitting, by the host system via the second interface and in accordance with the second communication protocol, a request for information from the memory system based on detecting the trigger condition to query the memory system; and
receiving, by the host system via the second interface and in accordance with the second communication protocol, the information from the memory system based on transmitting the request.

10. The method of claim 9, further comprising:
transmitting, via the second interface, authorization information that indicates the host system is authorized to access the information, wherein the information is received based on transmitting the authorization information.

11. The method of claim 9, wherein the first communication protocol comprises a first error protection scheme and the second communication protocol comprises a second error protection scheme.

12. The method of claim 9, wherein detecting the trigger condition comprises:
determining that a response to the command has not been received via the first interface within a threshold duration of transmitting the command.

13. The method of claim 9, wherein detecting the trigger condition comprises:
determining that a response to the command received via the first interface comprises an error.

14. The method of claim 9, further comprising:
transmitting, via the second interface, an indication to reset the memory system based on the information.

15. The method of claim 9, wherein the information comprises diagnostic information, the method further comprising:
determining a cause of the trigger condition based on the diagnostic information; and
transmitting, via the second interface, control information for resolving the cause of the trigger condition.

16. The method of claim 9, further comprising:
transmitting, via the second interface, a request for register information that indicates one or more statuses of the memory system; and
receiving, over the second interface, the register information based on transmitting the request for register information.

17. The method of claim 9, further comprising:
transmitting, via the second interface, a request for operational error information that indicates one or more operating errors of the memory system; and
receiving, via the second interface, the operational error information based on transmitting the request for operational error information.

18. The method of claim 9, wherein the first interface comprises:
a first transceiver at the host system, a first modulation circuit at the host system, and a first encoder circuit at the host system; and wherein the second interface comprises: a second transceiver at the host system, a second modulation circuit at the host system, and a second encoder circuit at the host system; and
a first demodulation circuit at the host system and a first decoder circuit at the host system; and wherein the second interface comprises: a second demodulation circuit at the host system and a second decoder circuit at the host system.

19. The method of claim 9, wherein the request for information is transmitted by a microcontroller of the host system.

20. An apparatus, comprising:
processing circuitry associated with one or more memory devices and configured to cause the apparatus to:
receive, by a memory system, a command via a first interface that comprises a first set of one or more input/output (I/O) pins and that operates according to a first communication protocol comprising a first modulation scheme and a first data rate;
receive, by the memory system via a second interface that comprises a second set of one or more I/O pins and that operates according to a second communication protocol comprising a second modulation scheme and a second data rate, a request for information from the memory system based on receiving the command; and
transmit, by the memory system via the second interface and in accordance with the second communication protocol, the information based on receiving the request.

21. The apparatus of claim 20, wherein the processing circuitry is further configured to cause the apparatus to:
receive, via the second interface, authorization information that indicates a host system is authorized to access the information, wherein the information is transmitted based on receiving the authorization information.

22. An apparatus, comprising:
processing circuitry associated with one or more memory devices and configured to cause the apparatus to:
transmit, by a host system, a command to a memory system via a first interface that comprises a first set of one or more input/output (I/O) pins and that operates according to a first communication protocol comprising a first modulation scheme and a first data rate;
detect, based on transmitting the command via the first interface, a trigger condition to query the memory system via a second interface that comprises a second set of one or more I/O pins and that operates according to a second communication protocol comprising a second modulation scheme and a second data rate;
transmit, by the host system via the second interface and in accordance with the second communication protocol, a request for information from the memory system based on detecting the trigger condition to query the memory system; and
receive, by the host system via the second interface and in accordance with the second communication protocol, the information from the memory system based on transmitting the request.

23. The apparatus of claim 22, wherein the processing circuitry is further configured to cause the apparatus to:
transmit, via the second interface, authorization information that indicates the host system is authorized to access the information, wherein the information is received based on transmitting the authorization information.
